(19) United States
(12) Patent Application Publication
(10) Pub. No.: US 2024/0239439 A1
(43) Pub. Date: Jul. 18, 2024

(54) Drive Assembly

(71) Applicant: Robert Bosch GmbH, Stuttgart (DE)

(72) Inventors: Julien Hassler, Kusterdingen (DE); Rainer Mast, Bondorf (DE); Quoc-Dat Nguyen, Neckartenzlingen (DE); Benjamin Bertsch, Lichtenstein (DE); Julian Binder, Wannweil (DE)

(21) Appl. No.: 18/560,155

(22) PCT Filed: May 5, 2022
(86) PCT No.: PCT/EP2022/062160

§ 371 Date: Nov. 10, 2023

(30) Foreign Application Priority Data
May 17, 2021 (DE) 10 2021 204 956.7
May 17, 2021 (DE) 10 2021 204 957.5
Apr. 29, 2022 (DE) 10 2022 204 221.2

(51) Int. Cl. B62M 6/55; B62K 19/34

(52) U.S. Cl. CPC B62M 6/55; B62K 19/34

(57) ABSTRACT

A drive assembly is for a vehicle that is operated using muscle power and/or a motor. The drive assembly includes a drive unit and an L-shaped frame interface having a base, a lateral wall, and an open face lying opposite the base. The drive unit is installed by way of the open face, in particular horizontally, and is releasably secured to the base.

### PRIOR ART

The present invention relates to a drive assembly, a vehicle comprising the drive assembly, and a method for producing a drive assembly.

Drive assemblies of vehicles, for example electric bicycles, are known, wherein a drive unit is screwed to a vehicle frame of a vehicle. The drive unit is often arranged partially between two walls of the vehicle frame. For the connection, an indirect screwing of the vehicle frame and the drive unit is often carried out via pieces of sheet metal, which are arranged on both sides of the drive unit. Typically, there is a gap between the drive unit and the second wall to be screwed. To bridge this gap, for example, one of the holding sheets can be deformed until it abuts the wall. However, this can have an adverse effect on the mechanical stress and the tightness of the drive assembly.

### DISCLOSURE OF THE INVENTION

By contrast, the drive assembly according to the invention having the features of claim 1 is characterized in that a particularly simple and stable design can be provided, which is suitable for adjusting optimal stress conditions on a drive unit. This is achieved by a drive assembly comprising a drive unit with a bottom bracket axle and a frame interface. The frame interface is configured in an L-shape. The L-shaped frame interface has a base and a lateral wall, wherein the side lying opposite the base is an open face. The drive unit can be mounted via this open face at the frame interface horizontally and parallel to or along a bottom bracket axle of the drive unit and thereby detachably attached to the base, preferably screwed. In contrast to the prior art, in which the drive unit is secured to a U-shaped frame interface and can only be introduced, e. g., inserted, vertically into the frame interface, in the L-shaped frame interface according to the invention the drive unit is arranged horizontally on the frame interface and then secured, for example screwed. By doing so, a particularly easy, horizontally mountable drive assembly can be provided.

In particular, the base of the frame interface is arranged on an output side of the drive unit and is substantially orthogonal or perpendicular to a bottom bracket axle of the drive unit. The lateral wall is arranged essentially at right angles to the floor and essentially parallel to the bottom bracket axle of the drive unit. The output side of the drive unit is the side on which the chainring is located with respect to a running direction of the vehicle. The output side is formed by the transmission output of the drive unit on the chainring side. The U-shaped frame interface known from the prior art has a bottom and two lateral walls which form the legs of the U-shaped frame interface. The side lying opposite the base is open. A drive unit can be mounted in the vertical direction via this one open face lying opposite the base. The drive unit is preferably inserted from bottom to top, but alternatively from top to bottom. The base of this known frame interface is arranged essentially parallel to a bracket axle of the drive unit. The two lateral walls arranged essentially at right angles to the base are accordingly located on an output side of the drive unit and on a side of the drive unit opposite the output side. Accordingly, the open face of the U-shaped frame interface according to the prior art points downwards, so that an assembly in vertical direction from bottom to top takes place. Alternatively, the open face of the U-shaped frame interface according to the prior art can also point upwards, so that assembly can be carried out in the vertical direction from top to bottom. In contrast to this known U-shaped frame interface, in the arrangement according to the invention with an L-shaped frame interface, the open face lying opposite the base is arranged in such a way that horizontal mounting from the side is possible. The terms “horizontal” and “vertical” refer to the usual arrangement of a drive unit on a frame interface of a vehicle powered by muscle power and/or a motor, in particular an electric bicycle. In such a usual arrangement of the drive unit at a frame interface, the bottom bracket axle of the drive unit is oriented essentially horizontally. A horizontal mounting is accordingly a mounting substantially parallel to or along the bottom bracket axle. A vertical mounting is accordingly a mounting essentially at right angles to the bottom bracket axis of the drive unit.

In particular, a receiving space of the frame interface is defined by the base and lateral wall. The drive unit is preferably arranged at least partially within the receiving space of the frame interface.

In the L-shaped arrangement of the lateral wall and base, the lateral wall can be partially or completely circumferential to the base. A fully circumferential lateral wall results in a pot-shaped design of the frame interface. Preferably, the base can be formed continuously. Alternatively, the base can have one or more recesses through which, for example, portions of the drive unit or other components can protrude. Preferably, the lateral wall can be continuous. Alternatively, it can also have one or more recesses through which, for example, parts of the drive unit or other components can pass. Any recesses that may be present can alternatively have other functions, e. g., serve to dissipate heat from the drive unit without parts of the drive unit protruding through the recess.

By means of a pot-shaped design of the frame interface, a mechanical protection of the drive unit can also be provided, for example, against rock impacts, mechanical contacts, or other environmental factors. In addition, a particularly high rigidity of the entire assembly can be provided by a pot-shaped frame interface. For example, a particularly large contact region with the drive unit can be provided by the lateral wall, wherein a particularly good distribution of the mechanical stresses can be enabled. For example, the stresses transferred from a vehicle frame to the drive unit can thereby be evenly distributed to the drive unit, for example, during strong braking maneuvers or the like.

The drive unit preferably has a housing, a bottom bracket axle, and, in particular within the housing, a motor and/or a transmission.

The subclaims relate to preferred further developments of the invention.

The drive unit is, in particular, screwed to the base via a fixed bearing assembly. In particular, the fixed bearing assembly is formed in that the base is screwed to at least one threaded bolt, preferably to a threaded screw, to at least one thread, preferably to a threaded sleeve, of a housing of the drive unit. In particular, the drive unit and the base are screwed directly by means of at least one screw. Preferably, the at least one screw is screwed into the drive unit from outside the frame interface through an opening of the base. As a result, a particularly stable connection of the drive unit and the frame interface can be provided.

Preferably, at least one holding region of the drive unit is arranged between a holding element and the base. The holding element is secured to both the lateral wall and the drive unit.

Particularly preferably, the drive assembly is configured such that at least the holding region of the drive unit between the holding element and the base is predefinedly stressed by tension or pressure when the drive assembly is fully secured. In particular, a state in which all screws are screwed to a stop with a predefined target torque is considered to be the fully secured state. The tensile stress or compressive stress is preferably adjusted in that the holding element is correspondingly adapted to a tolerance position of the holding region of the drive unit and frame interface such that, after screwing, the corresponding predefined tensile stress or compressive stress is present. Alternatively or additionally preferably, the tensile stress or compression stress is adjusted by specially adapted support points for the drive unit on the base of the frame interface. Preferably, a tolerance position of the drive assembly is adjusted for the compressive stress such that the holding element abuts the holding region of the drive unit before screwing, and at the same time a gap is present between the holding element and the lateral wall of the frame interface. For example, by fully screwing, this gap is closed and at least the holding region of the drive unit is clamped by pressure between the holding element and the base. Alternatively, for the tensile stress, the tolerance position of the drive assembly is adjusted such that the holding element abuts the lateral wall before screwing, and at the same time there is a gap between the holding element and the holding region of the drive unit. For example, this gap is closed by screwing and at least the holding region of the drive unit is stressed by tension between the base and the holding element. Thus, the optimal desired stress state of the drive unit can be adjusted in a particularly simple manner.

In other words, the holding element is located on a side of the holding region of the drive unit lying opposite the base. The holding element is secured, preferably screwed, to one front face of the lateral wall and the drive unit via a floating bearing assembly. For example, the drive unit is held at least partially within the receiving space by fastening the holding element. In addition, the stress conditions of the drive unit can be adjusted particularly simply and specifically by adjusting a gap between the holding element and the drive unit, or between the holding element and the lateral wall.

Preferably, the holding element is an elastically deformable, plate-shaped element. An elastically deformable plate-shaped element enables tolerance compensation between the frame interface and the drive unit in a particularly simple manner and can be individually adapted to the geometry of the frame interface as well as the drive unit. Furthermore, the use of ductile materials with low specific weight allows a particularly lightweight structure.

Preferably, the drive assembly has precisely two holding elements in order to enable a particularly simple and reliable connection of the drive unit and frame interface.

Furthermore, the holding element is preferably a planar piece of sheet metal. A planar piece of sheet metal as a holding element allows for a particularly simple and cost-effective design of the low-weight drive assembly. It is particularly advantageous when the drive assembly has two holding elements, each of which are flat pieces of sheet metal. Preferably, each piece of sheet metal is screwed to the lateral wall by means of exactly one screw and to the holding region of the drive unit by means of two screws.

Particularly preferably, the holding element is a stepped piece of sheet metal having two planar sheet portions. The two planar sheet portions are arranged with a predefined offset parallel to one another. The offset of the two sheet portions is considered in the unscrewed state of the holding element, i.e., without mechanical stress on the holding element. Preferably, the offset can change by screwing, for example by bridging a gap by means of the holding element. Preferably, the first flat sheet portion is screwed to the holding region of the drive unit, and the second flat sheet portion is screwed to the lateral wall. By means of the stepped piece of sheet metal, the tensile stress or the compressive stress of the holding region of the drive unit can be adjusted particularly simply and purposefully, in particular by adjusting the offset accordingly.

Furthermore, preferably, the holding element is a lid that abuts an entire front face of the lateral wall of the frame interface. Preferably, the lid thus covers substantially the entire holding space on its open face. Preferably, the lid is similar to the base, and in particular, together with the preferably L-shaped frame interface forms a substantially closed receiving space. For example, the lid can have recesses through which portions of the drive unit or further elements can protrude. For example, the lid can be formed from plastic, or alternatively from metal, for example aluminum. The lid allows for particularly good protection of the drive unit against environmental factors.

Particularly preferably, the lid has at least one opening, and per opening has an elastomeric element and a sleeve. The elastomeric element and the sleeve are arranged within the opening and screwed to the drive unit by means of a screw. The screw connection is such that the sleeve is pressed against the elastomeric element and the elastomeric element against the drive unit by means of the screw. In particular, in an end state, the sleeve can be in contact with the drive unit, preferably such that the elastomeric element is in a parallel force connection. The elastomeric element can enable a particularly reliable and robust screw connection, for example because vibrations or impacts can be dampened by a certain resiliency of the elastomeric element, in order to avoid damage. Advantageously, the elastomeric element also allows for a tolerance compensation of the screwing, preferably by radially flaring the elastomeric element by means of the sleeve and abutting against an inner wall of the opening. This fixes the elastomeric element axially and radially in the opening, thereby also fixing the lid and the drive unit relative to one another.

Furthermore, the lid is preferably designed as a spring-loaded lid. In this case, the drive unit is clamped between the contact area of the lid and the base of the frame interface. This can be done, for example, in an interlocking manner. The interlocking connection can be made, for example, by means of suitable center points between the contact area of the cover and the drive unit. Alternatively and/or additionally, the clamping can be non-positive. In the case of force-fit clamping, the drive unit is clamped under pressure between the contact area of the cover and the base of the frame interface.

Preferably, the drive assembly further comprises at least one fixing screw by means of which the contact area is directly screwed to the drive unit. In particular, the contact area and the drive unit are screwed together to a stop by means of the at least one fixing screw in the fully screwed state of the drive assembly. This enables a particularly stable fastening of the drive unit.

Preferably, the lid is designed in such a way that in the fully screwed state a compressive force of at least 50, preferably at least 200 N, preferably a maximum of 1600 N, in particular per screw-on point, is exerted on the drive unit between the lid and the base. In particular, a static state of the drive assembly is considered, i.e., without dynamic loads acting on the drive assembly due to vehicle operation, for example. This ensures that there is always a compressive stress on the drive unit even in the event of dynamic stresses on the frame arrangement. In particular, this can ensure a particularly reliable tightness of the drive unit, for example if it has interconnected housing halves.

Particularly preferably, the lid is plate-shaped and has a holding region and an offset spring region. The bearing region thereby surrounds the contact area. The bearing region can be screwed to the lateral wall of the frame interface. Preferably, only the bearing region of the lid is in contact with the lateral wall of the frame interface in the screwed state. The spring region connects the contact area and the bearing region to one another. In particular, the spring region is designed such that it connects the contact area and the bearing region to one another in a spring-elastic, that is, compliant, manner, wherein the spring region generates a restoring spring force. In other words, the lid is thus based on the principle of a disc spring. This makes it possible to provide spring elasticity of the lid in a simple manner with a low-cost design in order to reliably enable the lid to be clamped under pressure.

Preferably, the contact area and the bearing region of the lid are arranged parallel to each other in a predefined offset in the unscrewed, in particular in the unloaded, state of the lid. In particular, the predefined offset is such that the predefined compressive force is exerted on the drive unit by the spring elasticity of the lid when the contact area of the lid is fully screwed, i.e., to a stop, to the lateral wall of the frame interface.

Further preferably, the lid is designed to snap over in such a way that the contact area can snap over from one side of the holding plane to the other side of the holding plane with respect to a holding plane in which the holding region or the bearing region lies. In particular, the holding plane is a plane of symmetry of the holding portion, thus preferably centered between the two surfaces of the holding portion. In other words, the lid has two rest positions, in particular in each of which there is a plate-shaped design of the lid, preferably in each case according to the principle of a plate spring. This can enable particularly simple handling of the drive assembly. For example, the holding region can first be screwed to a stop with the lateral wall of the frame interface, and then the contact area can be pressed in the direction of the drive unit until it snaps over, in order to clamp the drive unit against the lid after snapping over.

Particularly preferably, the lid is configured such that the snapping occurs once the contact area is moved over a predefined tilt plane when the contact area is moved towards the holding plane. Preferably, the tilt plane corresponds to the holding plane. Alternatively, the tilt plane can also be arranged at a distance from the holding plane. This means that to initiate the snap-over, the holding region must be moved against the spring force of the spring region in the direction of the holding plane, i.e., in the direction of the holding region, in order to snap over to the corresponding other rest position after the tilt plane has been exceeded.

Preferably, the lateral wall completely surrounds the receiving space in the circumferential direction. That is to say, the receiving space is circumferentially fully closed by the lateral wall. This allows for a particularly good mechanical protection of the drive unit against environmental factors and a particularly uniform stress distribution between the drive unit and the frame interface.

Further preferably, the lateral wall has at least one recess, such that the receiving space is laterally open. Preferably, the recess extends over at least 20%, preferably a maximum of 80%, of the circumference of the lateral wall. Preferably, the recess extends over the entire height of the lateral wall. The recess in the lateral wall can provide a particularly inexpensive frame interface of low weight. In addition, the recess allows for better accessibility of the drive unit.

The invention furthermore leads to a vehicle, in particular a vehicle which is operated using muscle power and/or a motor, preferably an electric bicycle, which has the described drive assembly.

Preferably, the vehicle has a vehicle frame, wherein the frame interface is an integral component of the vehicle frame. The frame interface is preferably connected to a lower tube and/or to a seat tube and/or to chain stay of the vehicle frame, preferably respectively by means of a welded connection or a screwed connection or an adhesive connection. In particular, the frame interface is arranged such that a bottom bracket axle of the vehicle passes through the drive unit and the frame interface. Preferably, the frame interface is arranged such that the bottom bracket axle is substantially perpendicular to the base of the frame interface. By allowing the frame interface to be integrated into the vehicle frame, a particularly simple design can be made possible, which allows a robust and well-protected assembly of the drive unit. In addition, a particularly simple assembly of the drive unit can be enabled, because accessibility of the receiving space is only required from one side.

Also particularly preferably, the base of the frame interface is arranged on the output side of the drive unit. In addition to a particularly simple accessibility of the frame interface for the assembly of the drive unit, this enables an optimal transmission of power in the region of the drive assembly during operation of the vehicle. Due to the chain force, the highest force acts on the output side of the drive assembly. Because the base of the preferably pot-shaped frame interface is located here, this force can be distributed particularly evenly. If the drive unit is preferably screwed directly to the base, for example at a plurality of screw points distributed throughout the base, a particularly direct transmission of force between the drive unit and the frame interface can thus be achieved.

### BRIEF DESCRIPTION OF THE DRAWINGS

The invention is described in the following with reference to exemplary embodiments in conjunction with the figures. In the figures, functionally equivalent components are identified with the same respective reference numerals. The figures show:

FIG. 1 a sectional view of a drive assembly according to a first exemplary embodiment of the invention,

FIG. 2 a detail of a side view of a vehicle with the drive assembly of FIG. 1,

FIG. 3 a detail view of a frame interface of the drive assembly of FIG. 1,

FIG. 4 a detail view of a holding element of a drive assembly according to a second exemplary embodiment of the invention,

FIG. 5 a detail of a sectional view of the drive assembly according to the second exemplary embodiment of the invention,

FIG. 6 a detail of a further sectional view of the drive assembly of FIG. 5,

FIG. 7 a detail of a side view of a vehicle having a drive assembly according to a third exemplary embodiment of the invention, and

FIG. 8 a sectional view of a drive assembly according to a fourth exemplary embodiment of the invention.

FIG. 9 a detail view of a drive assembly according to a further embodiment example of the invention

FIG. 10 a sectional view of the drive assembly of FIG. 9 during assembly.

FIG. 11 a sectional view of the drive assembly of FIG. 9 fully assembled

FIG. 12 a schematic view of a vehicle in the form of a vehicle which is operated using muscle power and/or a motor, preferably an electric bicycle.

### PREFERRED EMBODIMENTS OF THE INVENTION

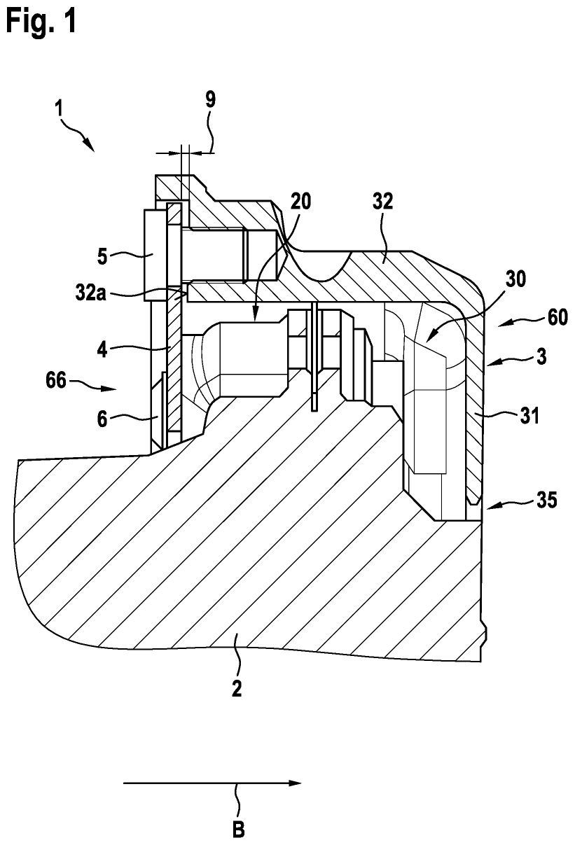

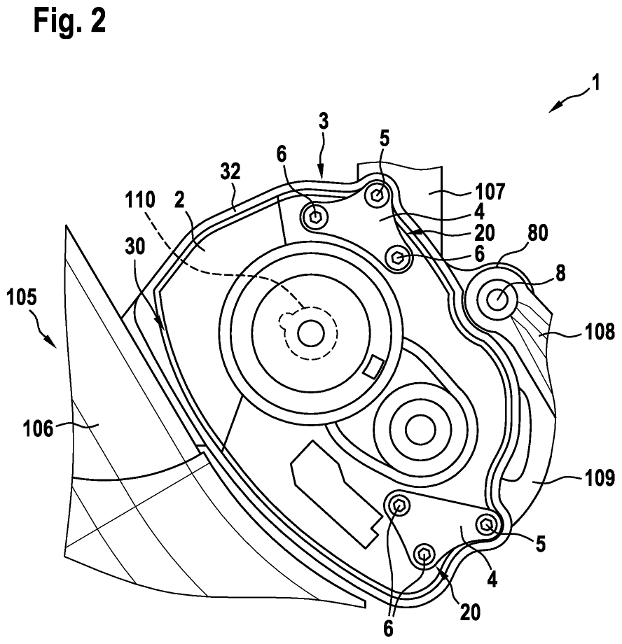

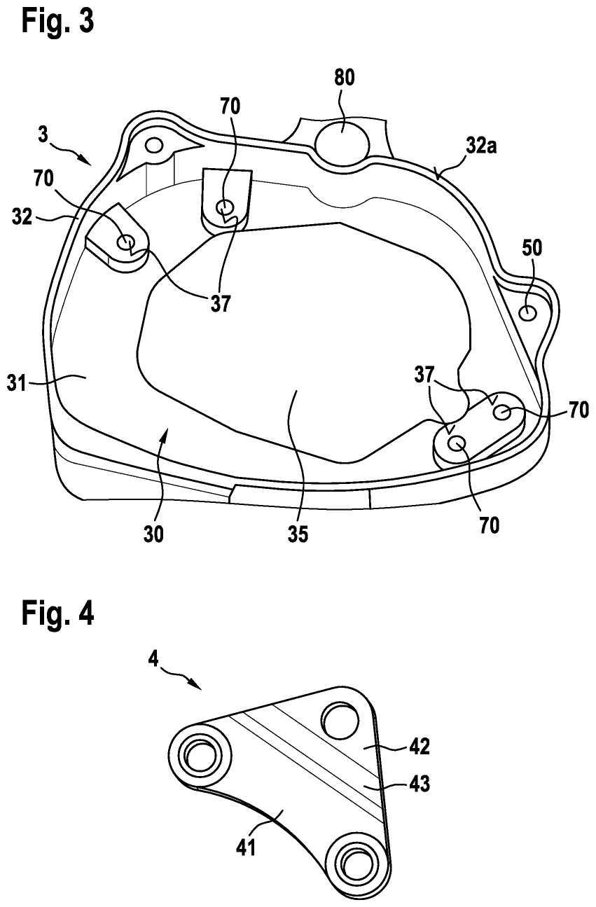

FIG. 1 shows a sectional view of a drive assembly 1 according to a first exemplary embodiment of the invention. The drive assembly 1 is part of a vehicle (not shown), which is an electric bicycle. The arrow marked with the letter B represents the mounting direction of the drive unit, which is essentially perpendicular to the running direction (see FIG. 12). The drive assembly 1 of the first exemplary embodiment is shown in further views in FIGS. 2 and 3.

The drive assembly 1 has a drive unit 2 comprising a motor and/or a transmission. Furthermore, the drive assembly 1 has a frame interface 3. The frame interface 3 is preferably shaped like a pot and has a base 31 and a lateral wall 32, which are arranged in an L-shape. For example, the base 31 and the lateral wall 32 define a receiving space 30 within which the drive unit 2 is partially arranged. The drive unit 2 abuts the base 31 at a plurality of support points 37 (cf. FIG. 3 or 9; not shown in FIG. 1) of the base 31.

As can be seen in FIG. 1, as well as in FIG. 3, the base 31 has a recess 35 through which a part of the drive unit 2 can at least partially project.

The drive assembly 1 further has a holding element 4, which is configured as a planar piece of sheet metal. The holding element 4 is screwed to the lateral wall 32 of the frame interface 3 by means of a first screw 5, and is also screwed to the drive unit 2 by means of two second screws 6 (cf. FIG. 2). As can be seen in FIGS. 1 and 2, the two screws 5, 6 are screwed into the lateral wall 32 and the drive unit 2 from the same side through the holding element 4.

Additionally, the drive unit 2 is screwed directly to the base 31 of the frame interface 3 from an opposite side. This screwing is not visible in FIGS. 1 and 2, but the corresponding bores 70 of the base 31, through which the associated screws are screwed into the drive unit 2, can be seen in FIG. 3.

FIG. 1 shows a state of the drive assembly 1 in which is not yet fully screwed. That is to say, the screws 5, 6 are not yet tightened to a stop at a predetermined target torque, in the state shown in FIG. 1. As can be seen in FIG. 1, there is a gap 9 between the holding element and a front face 32 a of the lateral wall. For example, the gap 9 can result from manufacturing tolerances or can have been specifically generated during the production of the frame interface 3.

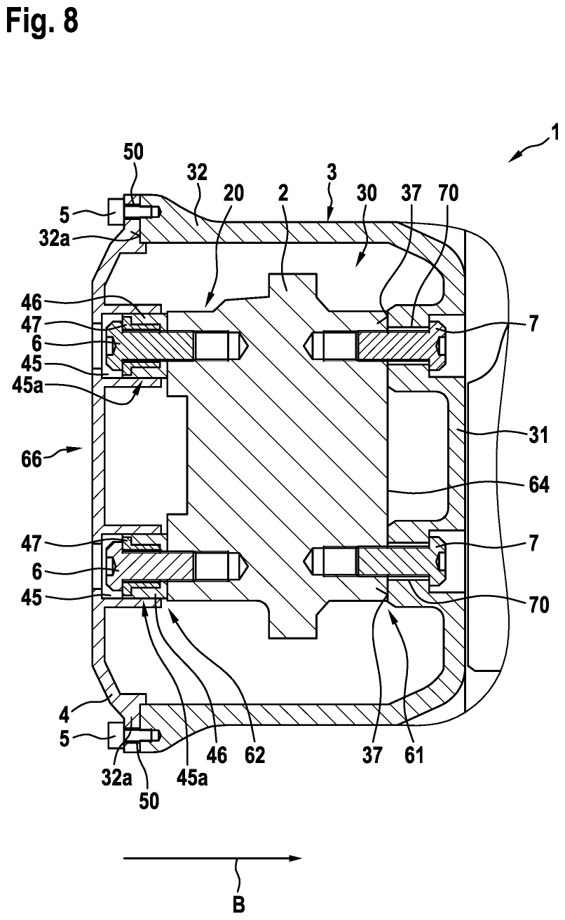

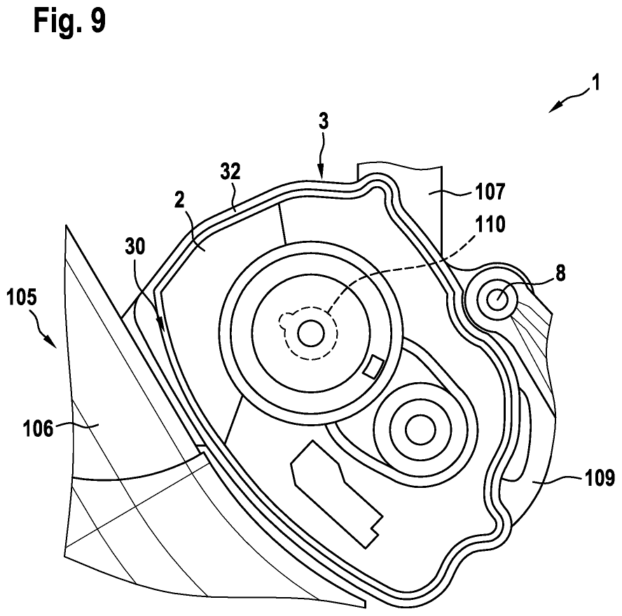

If the screws 5, 6 are tightened fully to the predetermined target torque, the holding element 4 is deformed until it abuts the front face 32a of the lateral wall 32 and is thus stressed by bending. A corresponding bending force is thereby applied to the holding region 20 of the drive unit 2 so that the holding region 20 between the holding element 4 and the base 31 is stressed by pressure. By applying pressure to the drive unit 2, a particularly favorable mechanical fastening can be achieved for a long lifetime of the drive unit 2. In addition, the compressive stress has a favorable effect on a reliable sealing of the drive unit 2, for example when it has a housing that can be formed from housing halves that are screwed together (cf. FIG. 8, 64).

As can be seen in FIG. 2, the lateral wall 32 circumferentially completely surrounds the drive unit 2. A particularly good protection of the drive unit 2 can thus be achieved. Furthermore, the bottom bracket axle 110 is shown. For example, the frame interface prevents direct mechanical effects on the drive unit 2, such as by rock impacts or bouncing on objects.

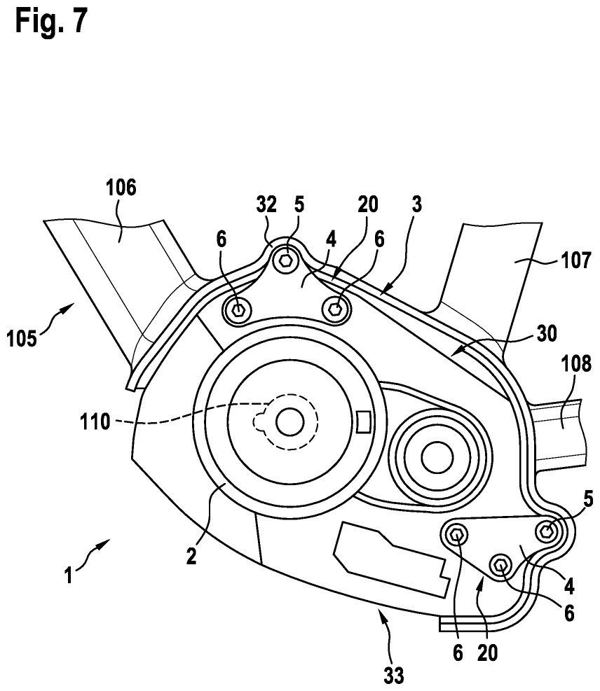

FIGS. 7 and 9 also show the joining of the frame interface 3 into the vehicle frame 105 of the electric bicycle. The frame interface 3 and the drive unit 2 are located around the bottom bracket axle 110 of the electric bicycle. The frame interface 3 is connected to a lower tube 106 and a seat strut 107 of the vehicle frame 105 by means of a welded connection.

Furthermore, the frame interface 3 has a hinge 8 which is integrated into an opening 80 within the lateral wall 32. By means of the hinge 8, a chain stay 108 of a (see FIG. 7) spring-loaded rear end of the electric bicycle is connected in an articulated manner to the frame interface 3.

The frame interface 3 is aligned on the vehicle frame 105 such that the base 31 (not visible in FIG. 2) is arranged on the output side 60 of the drive unit 2, i.e., closer to a chainring 109 than to the drive unit 2. The frame interface 3 opens on a side facing away from the chainring 109.

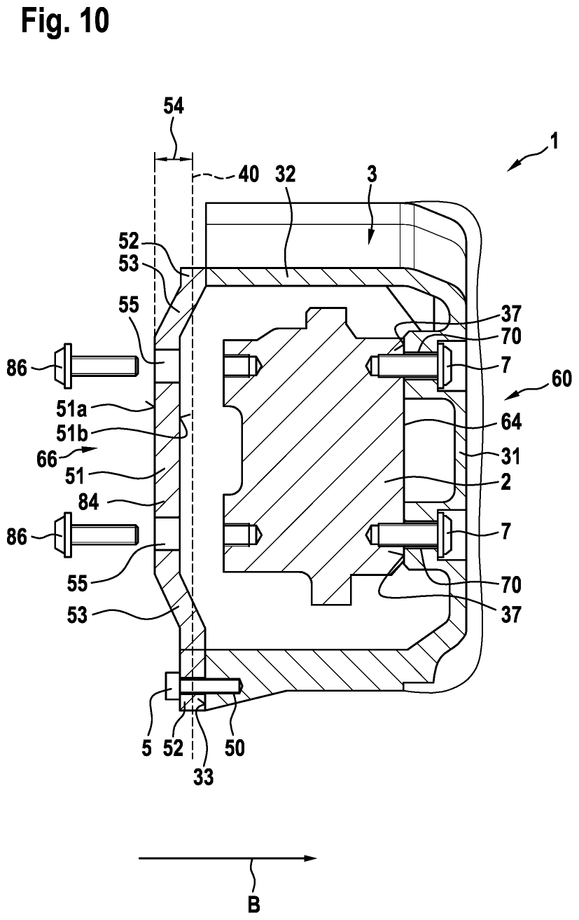

The frame interface 3, which is shown in detail in a perspective view in FIG. 3, is preferably a casting part formed from aluminum or an aluminum alloy. The support points 37 for the drive unit 2 are produced by milling after casting of the frame interface 3. Directly in the same chucking, bores 50, 70 (50 not required for all designs, see FIG. 10) can be drilled for all screws 5 or 85 as well as the opening 80 for the joint 8, wherein a particularly high accuracy, especially relative to one another, can be enabled for all elements produced by machining.

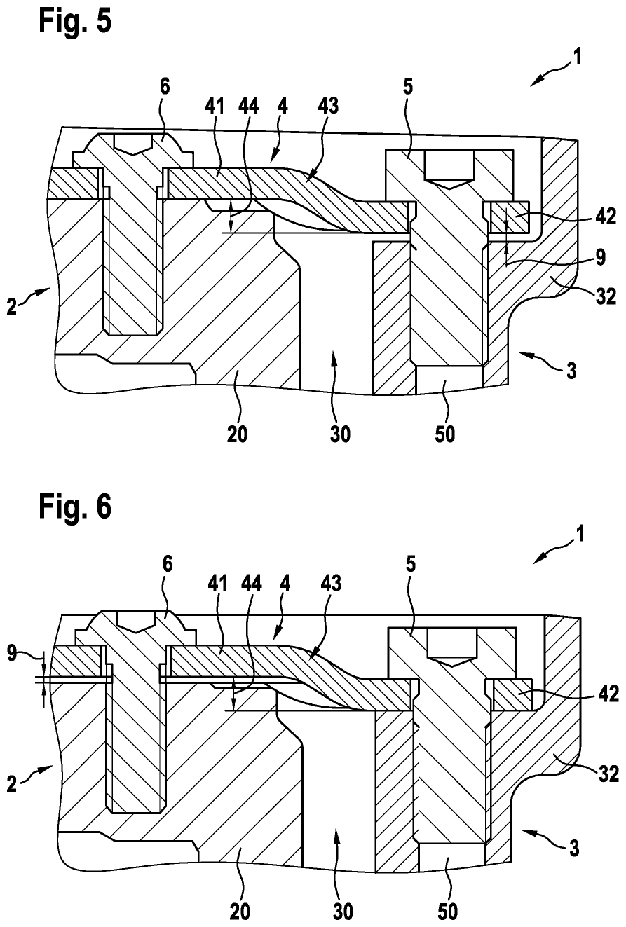

FIG. 4 shows a detail view of a holding element 4 of a drive assembly 1 according to a second exemplary embodiment of the invention. The drive assembly 1 of the second exemplary embodiment with variants of the holding element 4 shown in FIG. 4 is shown in FIGS. 5 and 6. The second exemplary embodiment substantially corresponds to the first exemplary embodiment of FIGS. 1 to 3, with the difference of an alternative holding element 4. In the second exemplary embodiment, the holding element 4 is a stepped piece of sheet metal having two planar sheet portions 41, 42. The two sheet portions 41, 42 are arranged parallel to one another and with a predefined offset 44 to one another in an unscrewed state, as shown in FIG. 4.

The offset 44 is configured so that, in the fully screwed state of the drive assembly 1, there is either a compressive stress or a tensile stress of the holding region 20 of the drive unit 2. The offset 44 is preferably dimensioned as a function of a tolerance position of the drive unit 2 and the frame interface 3. The two variants are shown in FIGS. 5 and 6.

FIG. 5 shows a holding element 4 with an offset 44, which is configured so that, in the unscrewed state and when a first sheet portion 41 of the holding element 4 abuts the holding region 20 of the drive unit 2, there is a gap 9 between the second sheet portion 42 and the lateral wall 32 of the frame interface 3. If the screws 5, 6 are fully tightened, the holding element 2 is bent until the second sheet portion 42 abuts the lateral wall 32. The holding region 20 is thereby stressed by pressure via the holding element 4 and between the holding element 4 and the base 31.

FIG. 6 analogously shows an alternative configuration of the holding element 4, wherein the offset 44 is configured such that, in the unscrewed state, a gap 9 is present between the first sheet portion 41 and the holding region 20. Because, in this state, the second holding region 42 already abuts the lateral wall 32, a full tightening of the screws 5, 6 causes the holding region 20 of the drive unit 2 to be stressed by tension.

FIG. 7 shows a detail of a side view of a vehicle having a drive assembly 1 according to a third exemplary embodiment of the invention. The third exemplary embodiment substantially corresponds to the first exemplary embodiment of FIGS. 1 to 3, with the difference that the frame interface 3 is configured so as to open on the side. In detail, in the third exemplary embodiment, the lateral wall 31 of the frame interface 3 has a recess 33, which extends over about 30% of a circumference of the lateral wall 31. The recess 33 is located on a vertically lower side and front side of the frame interface 3 in the direction of travel. The recess 33 allows for a particularly simple, inexpensive, and weight-saving design of the frame interface 3. In addition, the recess 33 allows for a particularly good accessibility of the drive unit 2.

FIG. 8 shows a sectional view of a drive assembly 1 according to a fourth exemplary embodiment of the invention. The fourth exemplary embodiment substantially corresponds to the first exemplary embodiment of FIGS. 1 to 3, with a further alternative design of the holding element 4. FIG. 8 also shows the direct screw connection of the drive unit 2 to the base 31 by means of further screws 7.

In the fourth exemplary embodiment of FIG. 8, the holding element 4 is configured as a lid, which abuts the entire front face 32a of the lateral wall 32. The holding space 30 can thereby be substantially closed by the lid 4, wherein the lid 4 can have a similar recess as the base 31 (cf. FIG. 3).

As in the first exemplary embodiment of FIGS. 1 to 3, in the fourth exemplary embodiment of FIG. 8, the lid 4 is screwed to the lateral wall 32 with first screws 5 and to a holding region 20 of the drive unit 2 with second screws 6.

In addition, the holding element 4 has two openings 45 and, per opening 45, an elastomeric element 46 and a sleeve 47, which are arranged within the corresponding opening 45. The sleeve 47 and the elastomeric element 46 are partially inserted into one another, wherein the elastomeric element 46 is arranged on a side of the sleeve 47 facing the drive unit 2. When tightening the screw 6, the sleeve 47 and the elastomeric element 46 are pushed towards the drive unit 2. The sleeve 47 pushes the elastomeric element 46 against the drive unit 2, in particular until the sleeve 47 comes into contact with the drive unit 2. Due to the elasticity of the elastomeric element 46, it is additionally radially flared by pressing, and it is pressed against an inner side 45a of the opening 45. Thus, the tolerance compensation between the holding element 4, the drive unit 2, and the lateral wall 32 is implemented by the elastomeric element 46 that has been pressed by means of screw 6 and sleeve 47.

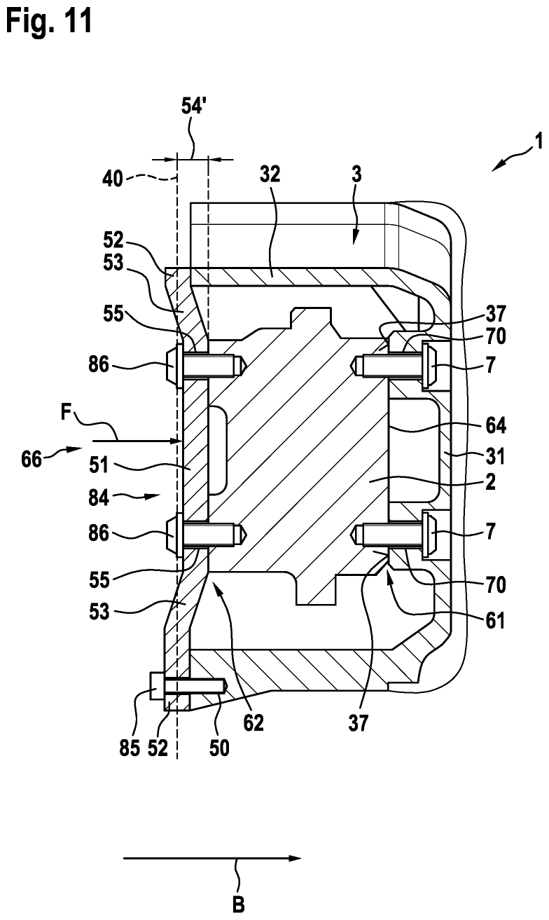

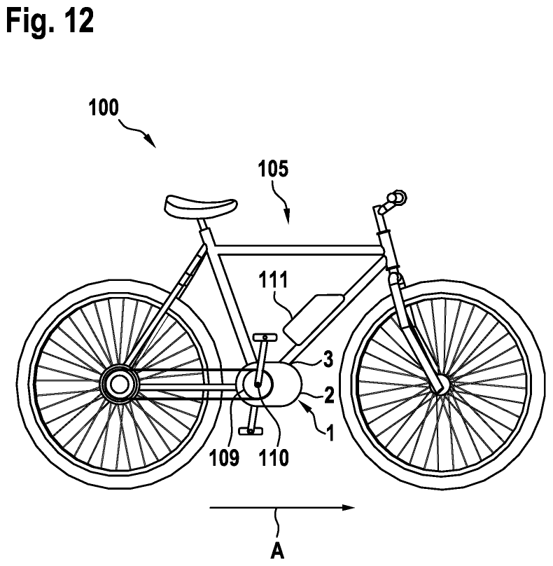

FIG. 9 shows a side view of a drive assembly 1 according to a preferred embodiment of the invention. The drive assembly 1 is part of the vehicle (only partially shown), which is an electric bicycle (see FIG. 12). In FIG. 9, the drive assembly 1 is only partially shown. Further views of the drive assembly 1 of the preferred exemplary embodiment are shown in FIGS. 10 and 11. FIG. 10 shows the drive assembly 1 not yet fully screwed together. In this case, a bearing region 52 is located on an front face 33 of the lateral wall 32.

The holding element shown here in a preferred embodiment of a resilient lid 4 is plate-shaped and has a contact area 51, a bearing region 52 which surrounds the contact area 51, and a spring region 53 which connects the bearing region 52 and the contact area 51 to one another. The bearing region 52 and the contact area 51 are arranged parallel to each other in the unloaded state of the resilient lid 84 at a predefined offset 54. This state is shown in FIG. 10.

The resilient lid 84 is plate-shaped and made of spring steel, so that the lid 4 has a resilience comparable to a plate spring.

In addition, the lid is designed to snap over so that the contact area 51 can snap over from one side of a holding plane 40 defined by the bearing region 52 to the other side of the holding plane 40. The holding plane 40 is a symmetry plane of the bearing region 52, that is, centered between the opposing surfaces of the bearing region 52. The snapping over occurs when the contact area 51 is moved completely over a tilt plane 40, which in the preferred embodiment corresponds to the holding plane 40.

The resilient lid 84 is designed in such a way that the snap-over is symmetrical with respect to the holding plane 40. That is, the spring-loaded lid 84 has two rest positions, in each of which a surface 51a, 51b of the contact area 51 is arranged at a predefined equal distance 54 from the holding plane 40.

A first rest position of the lid 84 is thereby shown in FIG. 10. In this state, i.e., during screwing to the lateral wall 32, the resilient lid is oriented such that the contact area 51 is located on a side of the lid facing away from the frame interface 3.

For further complete assembly of the drive assembly 1, at least one fixing screw 86 is inserted in a through opening 55 of the contact area 51 and screwed into the drive unit 2. By tightening the screw, the contact area 51 is moved towards the drive unit 2, thus also towards the holding plane 40. As soon as the contact area 51 has completely passed the holding plane 40, it snaps over.

In this case, the lid 84 is designed in such a way that the predefined distance 54 is greater than a distance 54′ between the holding plane 40 and the drive unit 2. This means that after snapping over, the lid 4 cannot assume its second rest position. As a result, the contact area 51 remains in a state pretensioned against the bearing region 52 by means of the spring region 43. Due to the spring elasticity of the resilient lid 84, a predefined compressive force F is hereby exerted on the drive unit 2. In other words, the drive unit 2 is clamped between contact area 51 and base 31 by means of the predefined compressive force F.

By applying pressure to the drive unit 2, a particularly favorable mechanical fastening can be achieved for a long lifetime of the drive unit 2. In addition, the compressive stress has a favorable effect on a reliable sealing of the drive unit 2, for example when it has a housing that can be formed from housing halves that are screwed together.

FIG. 12 shows a simplified schematic view of a vehicle 100 which is operated using muscle power and/or a motor and has a drive assembly 1 according to a first exemplary embodiment of the invention. The vehicle 100 is an electric bicycle. The arrow marked with the letter A represents the direction of travel of the electric bicycle. The drive assembly 1 is arranged in the region of a bottom bracket and has a drive unit 2. The drive unit 2 has an electric motor and a transmission, and is provided to support the rider's pedal force generated by muscle power by means of a torque generated by the electric motor. The drive unit 2 is supplied with electrical power by an electrical energy store 111. The drive assembly 1 has a frame interface 3. The frame interface 3 is an integral component of a vehicle frame 105 of the vehicle 100. An output shaft 108 is rotationally fixedly connected to a chainring 109. The bottom bracket axle 110 can be driven on the one hand by the muscle power of the rider and on the other hand by the motor power of the drive unit 2.

1. A drive assembly of a vehicle which is operated by muscle power and/or motor power, the drive assembly comprising:
a drive unit; and
an L-shaped frame interface including a base, a lateral wall, and an open face lying opposite the base,
wherein the drive unit is mountable over the open face, and is detachably secured to the base.

2. The drive assembly according to claim 1, wherein:
the base is arranged on an output side of the drive unit and is substantially orthogonal to a bottom bracket axle of the drive unit, and
the lateral wall is arranged substantially perpendicular to the base.

3. The drive assembly according to claim 1, wherein further comprising:
a fixed bearing assembly configured to releasably secure the drive unit to the base.

4. The drive assembly according to claim 3, wherein the base is screwed to at least one threaded bolt of a housing of the drive unit.

5. The drive assembly according to claim 4, wherein in a fully secured, screwed, state, at least one holding region of the drive unit between a holding element and the base is stressed by tension or pressure.

6. The drive assembly according to claim 5, further comprising:
a floating bearing assembly configured to secure the holding element to one front face of the lateral wall and the drive unit.

7. The drive assembly according to claim 5, wherein the holding element is an elastically deformable plate-shaped element.

8. The drive assembly according to claim 7, wherein the holding element is a planar piece of sheet metal.

9. The drive assembly according to claim 7, wherein:
the holding element is a stepped piece of sheet metal with two planar sheet portions, and
the two planar sheet portions are arranged parallel to one another with a predefined offset.

10. The drive assembly according to claim 5, wherein the holding element is a lid abutting a front face of the lateral wall.

11. The drive assembly according to claim 10, wherein:
the lid has at least one opening, and
an elastomeric element and a sleeve are arranged in the at least one opening and are screwed to the drive unit by a screw, such that the sleeve pushes the elastomeric element against the drive unit.

12. The drive assembly according to claim 10, wherein the lid is a resilient lid and clamps the drive unit between a contact area of the lid and the base in compression.

13. The drive assembly according to claim 12, further comprising:
at least one fixing screw configured to screw the contact area directly to the drive unit.

14. The drive assembly according to claim 13, wherein the lid is configured to exert a compressive force of at least 50 N on the drive unit in a fully screwed state.

15. The drive assembly according to claim 13, wherein:
the lid is plate-shaped with a bearing region and a spring region,
the bearing region surrounds the contact area, and
the spring region connects the contact area and the bearing region to each other.

16. The drive assembly according to claim 15, wherein the contact area and the bearing region are arranged parallel to each other at a predefined offset in an unscrewed, unloaded, state of the lid.

17. The drive assembly according to claim 14, wherein the lid is configured to snap over, such that the contact area snaps over from one side of a holding plane to another side of the holding plane with respect to a holding plane in which the bearing region is located.

18. The drive assembly according to claim 17, wherein the lid is configured such that the snapping over occurs when the contact area is moved in a direction of the holding plane over a predefined tilting plane.

19. The drive assembly according to claim 1, wherein the lateral wall circumferentially completely surrounds the base.

20. (canceled)

21. A vehicle which is operated using muscle power and/or a motor, comprising:
a drive assembly including (i) a drive unit, and (ii) an L-shaped frame interface including a base, a lateral wall, and an open face lying opposite the base,
wherein the drive unit is mountable over the open face, and is detachably secured to the base.
